(19) United States
(12) Patent Application Publication
(10) Pub. No.: US 2007/0113485 A1
(43) Pub. Date: May 24, 2007

(54) Door module positioning system

(75) Inventors: Everardo A. Hernandez, Shelby Township, MI (US); Santhosh Kumar Karumuri, Inkster, MI (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/313,569

(22) Filed: Dec. 21, 2005

Related U.S. Application Data
(63) Continuation-in-part of application No. 11/284,662, filed on Nov. 22, 2005.

(51) Int. Cl. B60J 5/04

(52) U.S. Cl. 49/502

(57) ABSTRACT

A door module assembly includes a carrier plate having a plurality of locating pins. An inner door panel includes a plurality of openings that cooperate with the plurality of locating pins to align the carrier plate relative to the inner door panel and to retain the carrier plate on the inner door panel without requiring fasteners. Each locating pin comprises a pin body with a slot that separates the pin body into first and second flexible lip portions. These first and second lip portions flex inwardly toward each other during insertion into the inner door panel, and flex outwardly away from each other after insertion through the inner door panel to retain the carrier plate on the inner door panel without requiring any additional fastening elements.

### RELATED APPLICATIONS

This application is a continuation-in-part application claiming priority of U.S. patent application Ser. No. 11/284,662, filed Nov. 22, 2005.

### TECHNICAL FIELD

The subject invention relates to a door module positioning system with a slotted pin that allows a carrier plate to be initially supported and retained on an inner door panel during assembly without requiring fasteners.

### BACKGROUND OF THE INVENTION

Door module assemblies include a carrier plate that supports components such as door locks and window lifters, for example. The carrier plate is attached to an inner door panel on a vehicle door. Typically, the carrier plate includes locating pins that are inserted into openings formed in the inner door panel to align the carrier plate relative to the inner door panel.

Traditionally, each locating pin comprises a cylindrical steel pin that is attached to the carrier plate as a separate piece. This requires additional assembly steps, and accordingly increases cost. Further, these cylindrical steel pins are typically orientated in a perpendicular relationship to the carrier plate. Corresponding openings extend perpendicularly into one side of the inner door panel. One disadvantage with this configuration is that the carrier plate must be immediately fastened to the inner door panel to retain the carrier plate to the inner door panel. Thus, the locating pins alone cannot be used to retain the carrier plate to the inner door panel while other assembly operations are being conducted.

This perpendicular orientation of the locating pins could result in the carrier plate sliding away and separating from the inner door panel if the carrier plate and inner door panel are not immediately fastened together after alignment. This means that the alignment and attachment steps must be performed at the same assembly line station. This makes assembly more difficult and expensive.

Thus, there is a need for a door module positioning system that uses a common feature to both locate and retain the carrier plate and inner door panel together. Further, this common feature should not require immediate permanent attachment between the carrier plate and the inner door panel. This feature allows the door module assembly to be moved between assembly line stations or to have additional assembly steps performed prior to permanent attachment, as desired.

### SUMMARY OF THE INVENTION

A door module assembly includes a carrier plate and an inner door panel. One of the carrier plate and inner door panel includes at least one locating pin that is used to align and retain the carrier plate and inner door panel together without requiring any additional fasteners. Each locating pin includes a pin body with a removed section that allows the locating pin to flex during assembly.

In one example, the removed section comprises a slot that extends to a distal end of the pin body. The slot separates the pin body into first and second lip portions. The first and second lip portions flex toward each other during insertion of the locating pin through an opening, and the first and second lip portion flex outwardly away from each other after the locating pin has been inserted through the opening to retain the carrier plate to the inner door panel.

By using slotted locating pins for alignment and retention of the carrier plate on the inner door panel, carrier plate separation is avoided and subsequent assembly steps can be performed without requiring permanent attachment of the carrier plate to the inner door panel. Permanent attachment can then occur subsequent to any desired assembly operations.

These and other features of the present invention can be best understood from the following specification and drawings, the following of which is a brief description.

### BRIEF DESCRIPTION OF THE DRAWINGS

FIG. 1 is a schematic side view of a door module assembly incorporating the subject invention.

FIG. 2 is a perspective view of a carrier plate and locating pin incorporating the subject invention.

FIG. 3 is a magnified side view of the locating pin of FIG. 2.

FIG. 4 is a schematic view showing insertion of the subject locating pin into an inner door panel.

FIG. 5 is a schematic view showing the subject locating pin after insertion into the inner door panel.

### DETAILED DESCRIPTION OF THE PREFERRED EMBODIMENT

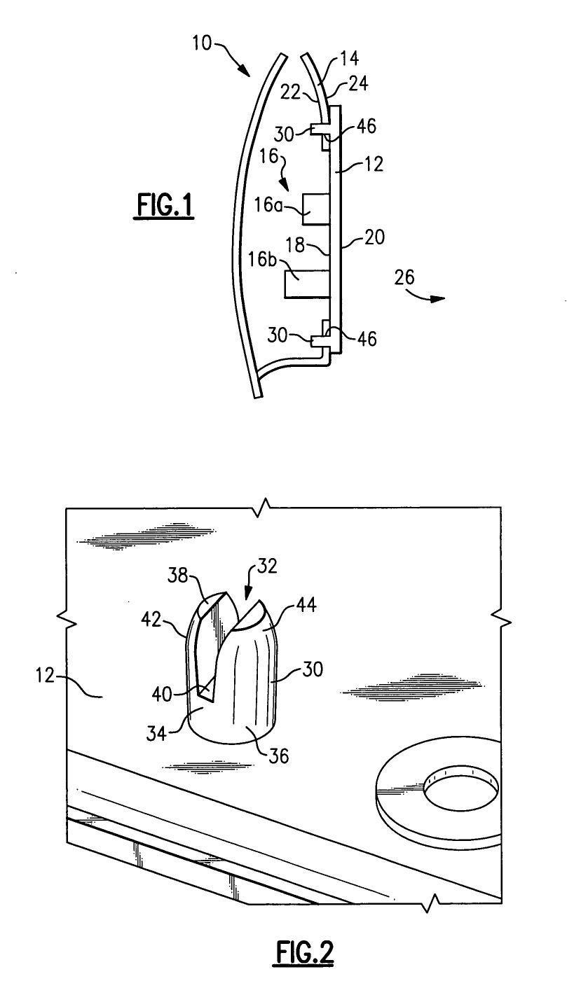

A door module assembly 10 is shown schematically in FIG. 1. The door module assembly 10 includes a carrier plate 12 and an inner door panel 14. Door module components 16 are mounted to the carrier plate 12. The door module components 16 can be any type of known door module component such as a window lifter mechanism 16a or a door lock mechanism 16b (shown schematically), for example.

The carrier plate 12 includes an outer surface 18 and an inner surface 20 that faces away from the inner door panel 14. The inner surface 20 of the carrier plate 12 faces towards a passenger compartment. Location of the passenger compartment is generally indicated by arrow 26. The inner door panel 14 includes an outer surface 22 that faces away from the carrier plate 12 and an inner surface 24 that faces the outer surface 18 of the carrier plate 12.

The carrier plate 12 includes at least one locating pin 30 that is used to align and retain the carrier plate 12 on the inner door panel 14 without requiring any other fastening elements. Preferably, a plurality of locating pins 30 is used for alignment and retention. As shown in FIG. 2, each locating pin 30 includes a removed section 32 that provides the locating pin 30 with a resilient retention feature that allows the locating pin to flex between different positions during assembly of the carrier plate 12 to the inner door panel.

As shown in FIG. 2, each locating pin 30 comprises a pin body 34 having a base end 36 and a distal end 38. The removed section 32 comprises a slot 40 that extends from the base end 36 to the distal end 38. The slot 40 separates the pin body 34 into first 42 and second 44 flexible lip portions that are resiliently formed to move between different installation positions.

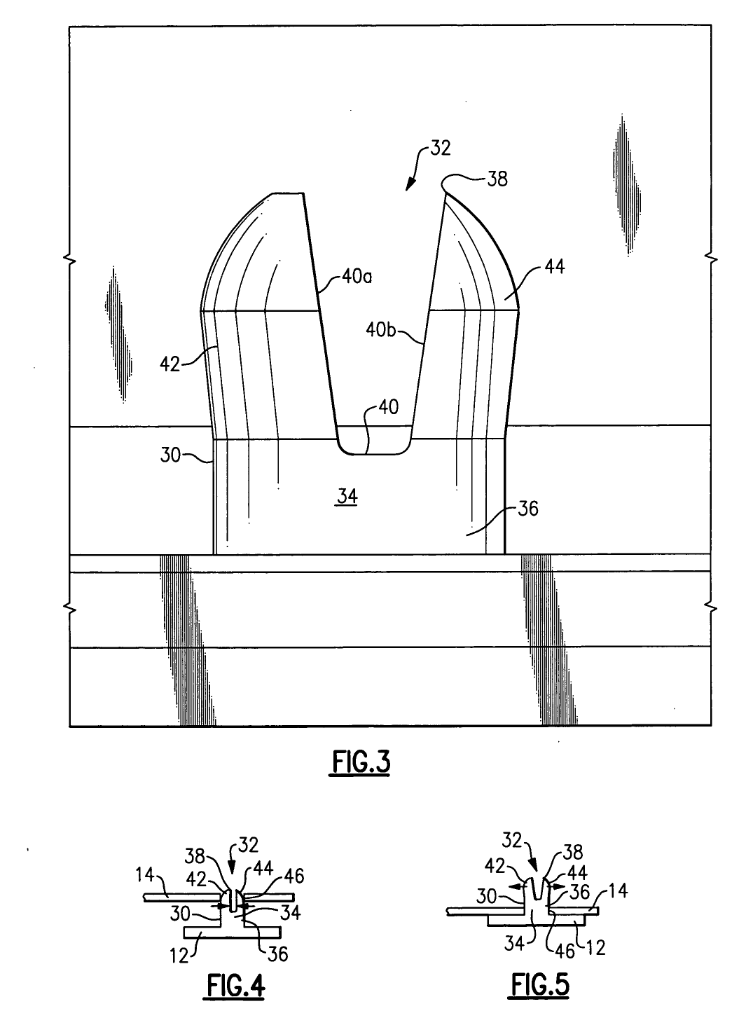

As shown in FIG. 3, the slot 40 is comprised of a pair of tapered surfaces 40a, 40b that diverge away from each other in a direction extending from the base end 36 toward the distal end 38. This allows the first 42 and second 44 flexible lip portions to have greater flexibility at the distal end 38 than at the base end 36.

Each locating pin 30 is inserted into a corresponding opening 46 (FIG. 1) formed in the inner door panel 14. During insertion of the locating pin 30 into the opening 46, the first 42 and second 44 flexible lip portions flex inwardly toward each other as shown in FIG. 4. After the locating pin 30 has been inserted through the opening 46, the first 42 and second 44 flexible lip portions return to their initial position, i.e. the first 42 and second 44 flexible lip portions flex outwardly away from each other, as shown in FIG. 5. This provides a retention feature that prevents the carrier plate 12 from sliding off of the inner door panel 14.

Preferably, the locating pins 30 are integrally formed with the carrier plate 12 as a single piece component. This eliminates the need for separate steel pins as are traditionally required, and correspondingly decreases cost and assembly time. Preferably, the locating pins 30 and carrier plate 12 are made from the same type of plastic material during a molding process. Further, it should be understood that while the locating pins 30 are shown as being formed on the carrier plate 12 with openings 46 formed in the inner door panel 14, a reverse configuration could also be utilized with locating pins formed on the inner door panel 14 and openings formed on the carrier plate 12.

The slotted locating pins 30 provide both alignment and retention capability for the carrier plate 12 within the door module assembly 10. The locating pins 30 and openings 46 cooperate to align the carrier plate 12 relative to the inner door panel 14. The locating pins 30 resiliently snap into the openings 46 to retain the carrier plate 12 to the inner door panel 14. Panel separation is avoided and subsequent assembly steps can be performed without requiring permanent attachment of the carrier plate 12 to the inner door panel 14. The carrier plate 12 and the inner door panel 14 can then be fastened together subsequent to any desired assembly operations, such as attachment of door module components 16 within the door module assembly 10, for example.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A door module assembly comprising:
a carrier plate mountable to an inner door panel; and
one of a locating pin and an opening formed on said carrier plate to cooperate with the other of the locating pin and opening formed on the inner door panel to provide a retention feature, wherein the locating pin includes a pin body having a removed section, said pin body being received in the opening to align said carrier plate relative to the inner door panel with said retention feature retaining said carrier plate on the inner door panel without requiring additional mounting components.

2. The door module assembly according to claim 1 wherein said locating pin extends from said carrier plate and wherein the opening is formed in the inner door panel.

3. The door module assembly according to claim 2 wherein said locating pin is integrally formed with said carrier plate as a single piece component.

4. The door module assembly according to claim 3 wherein said carrier plate and said locating pin are formed from a common plastic material.

5. The door module assembly according to claim 2 wherein said removed section comprises a slot.

6. The door module assembly according to claim 5 wherein said locating pin includes a base end formed with said carrier plate and a distal end that is inserted into said opening, and wherein said slot extends from said base end to said distal end to separate said pin body into first and second lip portions.

7. The door module assembly according to claim 6 wherein said first and second lip portions move inwardly towards each other during insertion of said first and said second lip portions into said opening and wherein said first and said second lip portions move outwardly away from each other after said first and said second lip portions have been inserted through said opening.

8. The door module assembly according to claim 5 where said slot is defined by a pair of tapered surfaces.

9. A door module assembly comprising:
a carrier plate;
an inner door panel facing said carrier plate;
at least one locating pin integrally formed with said carrier plate, said at least one locating pin including a removed section such that said at least one locating pin is movable between first and second positions during attachment of said carrier plate to said inner door panel; and
at least one opening formed within said inner door panel wherein said at least one locating pin cooperates with said at least one opening to align said carrier plate relative to said inner door panel and to retain said carrier plate on said inner door panel without requiring additional mounting components.

10. The door module assembly according to claim 9 wherein said at least one locating pin moves from said first position to said second position during insertion of said at least one locating pin into said at least one opening, and wherein said at least one locating pin moves from said second position to said first position after said at least one locating pin has been inserted through said at least one opening.

11. The door module assembly according to claim 10 wherein said removed section comprises a slot.

12. The door module assembly according to claim 11 wherein said at least one locating pin includes a pin body having a base end formed with said carrier plate and a distal end that is inserted into said at least one opening, said slot extending from said base end to said distal end to separate said pin body into first and second lip portions that flex between said first and said second positions.

13. The door module assembly according to claim 11 wherein said slot includes a pair of tapered surfaces.

14. The door module assembly according to claim 10 wherein said at least one locating pin has a portion with a greater diameter than said at least one opening when in said first position, and wherein said portion has a smaller diameter than said at least one opening when in said second position.

15. A method of attaching a carrier plate to an inner door panel comprising:
(a) providing a carrier plate having at least one locating pin comprising a pin body having a slot extending to a distal end to separate the pin body into first and second flexible lip portions;
(b) moving the first and second flexible lip portions towards each other during insertion of the pin body into an opening in the inner door panel to align the carrier plate relative to the inner door panel; and
(c) moving the first and second flexible lip portions away from each other after insertion of the pin body through the opening to retain the carrier plate on the inner door panel without requiring additional mounting components.

16. The method according to claim 15 including forming the slot with a pair of tapered surfaces.

17. The method according to claim 15 including integrally molding the at least one locating pin and carrier plate together as a single piece component.

18. The method according to claim 15 including (d) fastening the carrier plate to the inner door panel subsequent to step (c).

19. The method according to claim 15 including mounting at least one door module component to the carrier plate independently from the at least one locating pin.

20. The method according to claim 19 wherein the at least one door module component includes at least one of a window lift mechanism and door lock mechanism.
